(19) United States
(12) Patent Application Publication
(10) Pub. No.: US 2024/0265381 A1
(43) Pub. Date: Aug. 8, 2024

(54) CUSTODY SERVICE FOR AUTHORISING TRANSACTIONS

(71) Applicant: THE BLOCKHOUSE TECHNOLOGY LIMITED, Oxford (GB)

(72) Inventors: Pedro ANTONINO, Oxford (GB); Ante DEREK, Oxford (GB); Tomislav HECIMOVIC, Oxford (GB); Mario MATIJASEVIC, Oxford (GB); Vedran NOVOSELAC, Oxford (GB); Ivan VIDAKOVIC, Oxford (GB)

(73) Assignee: THE BLOCKHOUSE TECHNOLOGY LIMITED, Oxford (GB)

(21) Appl. No.: 18/562,484

(22) PCT Filed: May 23, 2022
(86) PCT No.: PCT/GB2022/051295

§ 371 Date: Nov. 20, 2023

(30) Foreign Application Priority Data
May 21, 2021 (GB) 2107302.8

(51) Int. Cl. G06Q 20/38

(52) U.S. Cl. CPC G06Q 20/3829

(57) ABSTRACT

A computer system comprises a networked custody server for signing transactions on behalf of a plurality of users. The custody server includes a processor that provides a trusted execution environment for securely decrypting and executing software instructions stored in an encrypted enclave of the custody server. A plurality of users' private keys are stored in the encrypted enclave with a respective access policy. The custody server receives a request to sign a transaction on behalf of a user, and user-authentication data for the user, and determines within the trusted execution environment whether the user-authentication data satisfies the access policy associated with the user. If so, it uses the user's private key to sign the transaction within the trusted execution environment.

### BACKGROUND OF THE INVENTION

This invention relates to a computer system comprising a custody server for authorising transactions on behalf of a user.

As humanity increasingly accesses services digitally, the challenge of enabling users to maintain control of their digital identities, while also providing service providers with confidence in the veracity of those identities, becomes increasingly important and complex.

This can be seen especially, for example, in the area of cryptocurrency, where transactions can potentially be of high financial value. Cryptocurrency transactions are often inherently anonymous, and yet a recipient of currency (e.g. a provider of goods or services) will often need to match transactions with the real-world identities of their customers, with a high degree of confidence in those identities.

Cryptographic keys can allow users to sign digital transactions for authentication using private keys associated with the user. However, managing and using such private cryptographic keys is a complex process that is difficult for users to handle securely, while also providing confidence to other parties who need to rely on the authentication they provide.

Embodiments of the present invention seek to provide an improved way of performing transactions.

### SUMMARY OF THE INVENTION

From a first aspect, the invention provides a computer system comprising a custody server for signing transactions on behalf of a user,
wherein the custody server comprises a processor configured to provide a trusted execution environment for securely decrypting and executing software instructions that are stored in an encrypted enclave of the custody server, and
wherein the custody server is configured for:
   storing a private key of a transaction-signing key pair, associated with a user, in the encrypted enclave;
   storing policy data defining an access policy for the transaction-signing key pair in the encrypted enclave;
   receiving a request to sign a transaction on behalf of the user;
   receiving user-authentication data for the user;
   determining, within the trusted execution environment, whether the user-authentication data satisfies the access policy for the transaction-signing key pair; and
   when the user-authentication data satisfies the access policy, using the private key to sign the transaction, within the trusted execution environment, on behalf of the user, and outputting data representative of the signed transaction.

From a second aspect, the invention provides a computer-implemented method of operating a custody service for signing transactions on behalf of a user, the method comprising:
storing a private key of a transaction-signing key pair, associated with a user, in an encrypted enclave;
storing policy data defining an access policy for the transaction-signing key pair in the encrypted enclave;
receiving a request to sign a transaction on behalf of a user;
receiving user-authentication data for the user;
determining, within a trusted execution environment, whether the user-authentication data satisfies the access policy for the transaction-signing key pair; and
in response to determining that the user-authentication data satisfies the access policy, using the private key to sign the transaction, within the trusted execution environment, on behalf of the user, and outputting data representative of the signed transaction.

From a third aspect, the invention provides a computer program comprising instructions which, when executed by a computer system, cause the computer system to provide a custody service for signing transactions on behalf of a user, by:
storing a private key of a transaction-signing key pair, associated with a user, in an encrypted enclave;
storing policy data defining an access policy for the transaction-signing key pair in the encrypted enclave;
receiving a request to sign a transaction on behalf of a user;
receiving user-authentication data for the user;
determining, within a trusted execution environment, whether the user-authentication data satisfies the access policy for the transaction-signing key pair; and
in response to determining that the user-authentication data satisfies the access policy, using the private key to sign the transaction, within the trusted execution environment, on behalf of the user, and outputting data representative of the signed transaction.

Thus it will be seen that, in accordance with embodiments of the invention, a user's private key is held securely in an encrypted enclave of a server, and the user can then instruct the custody server to sign transactions on the user's behalf, within a trusted execution environment (“TEE”) of the server. The server is referred to herein as a “custody server”, because it acts as custodian for the key. The custody server can thus relieve the user of the burden and risk of having to handle his or her private keys, thereby providing convenience for the user and confidence to recipients of the signed transaction.

The transaction may be any form of transaction. However, in some embodiments it is a financial transaction. It may be a cryptocurrency transaction—e.g. a transfer of value into or out of a wallet. The private key may be a wallet key.

The access policy for the key pair may specify one or more authentication attributes. The custody server may determine, within the TEE, whether the user-authentication data satisfies an authentication attribute specified by the access policy. It may be configured to use the private key to sign the transaction, on behalf of the user, at least in part in response to determining that the user-authentication data satisfies an authentication attribute specified by the access policy. An authentication attribute specified by the access policy may, in some embodiments, specify a required type of user-authentication data required of the user. It may represent a selection of a type from a plurality of predetermined types of user-authentication data, which may, in some embodiments, be an ordered set—e.g. corresponding to a succession of levels or strengths of authentication.

The access policy for the key pair may specify one or more transaction attributes. The custody server may determine, within the TEE, whether one or more transaction attributes specified by the access policy is met by the transaction. It may be configured to use the private key to sign the transaction, on behalf of the user, at least in part in response to determining that the transaction satisfies one or more transaction attributes specified by the access policy. A transaction attribute specified by the access policy may, in some embodiments, specify a maximum value for the transaction.

In some embodiments, the access policy may specify a plurality of transaction attributes and a plurality of authentication attributes. It may associate each transaction attribute of the plurality of transaction attributes with at least one authentication attribute of the plurality of authentication attributes. The custody server may be configured to determine whether the received user-authentication data satisfies an authentication attribute associated with a transaction attribute of the transaction. It may be configured to use the private key to sign a transaction, on behalf of the user, at least in part in response to determining that the received user-authentication data satisfies every authentication attribute associated with every transaction attribute of the transaction.

The access policy may, in some embodiments, specify a type (e.g. a level) of user-authentication data that the received user-authentication data must satisfy, selected from a plurality of types in dependence on the value of the transaction. For example, the policy may specify that transactions above a threshold value require two independent attestations of the user's identity (e.g. two-factor authentication), whereas transactions below the threshold require only one attestation.

The user-authentication data may be received from the user (e.g. comprising a password provided by the user), or it may be received from another entity (a third-party identity provider). The user-authentication data may comprise a user identifier (e.g. a unique user ID). It may comprise a signed or encrypted user identifier, which may serve to

The computer system may be configured to receive the user-authentication data from a user device. The user device may be a portable computing device, such as a smartphone or tablet computer. It be an element of the computer system embodying the invention. The user device may execute an application (e.g. an app) which may comprise instructions for communicating with the custody server. The user device may store one or more client access keys for authenticating the user device to the custody server and/or for communicating securely (i.e. over an encrypted channel) with the custody server. It may use an authorisation client access key for signing instructions to the custody server. It may use a cipher client access key (e.g. a TLS key pair) for communicating securely with the custody server.

The server may be configured to receive device-authentication data for the user device—e.g. generated using a client access key (i.e. a secret device key) stored on the user device. The server may use a client access key stored on the server to authenticate (i.e. validate) the user device. The client access key may be associated with the user on the server. It may be associated with the user in mapping data stored by the server. The custody server may store device-to-key mapping data that associates one or more cryptographic client access keys, which may be associated with a user device (e.g. by means of a custody-service app installed on the user's device), with the user's transaction-signing key pair.

The device-authentication data may form part or all of the user-authentication data (i.e. the user-authentication data may comprise the device-authentication data), or the device-authentication data may be separate from (e.g. additional to) the user-authentication data. The access policy may additionally depend on the device-authentication data. The server may be configured to determine whether the received device-authentication data satisfies the access policy for the transaction-signing key pair. It may be configured use the private key to sign the transaction on behalf of the user only after determining that the device-authentication data satisfies the access policy. In this way, the user's private key on the custody server (e.g. a wallet key) can effectively be bound to the user's device, such as the user's smartphone; this can enable multi-factor security for the private key.

In some embodiments and/or circumstances, the user-authentication data may comprise a user identifier for the user, cryptographically signed by a private key associated with the user device (e.g. a client access key), or signed by a private key associated with a transaction-processing system (e.g. a transaction-processing-system-access key, as described below). Such user-authentication data may be used to authenticate the user and the user device or the transaction-processing system to the server.

The custody server may be configured for authorising transactions on behalf of a plurality of users.

Thus, when viewed from a further aspect, the invention provides a computer system comprising a networked custody server for signing transactions on behalf of a plurality of users,
wherein the networked custody server comprises a processor configured to provide a trusted execution environment for securely decrypting and executing software instructions that are stored in an encrypted enclave of the custody server, and wherein the custody server is configured to:
   store a plurality of private keys of respective transaction-signing key pairs, associated with a plurality of respective users, in one or more encrypted enclaves of the custody server;
   store policy data defining a respective access policy for each transaction-signing key pair in the one or more encrypted enclaves;
   receive a request to sign a transaction on behalf of a user of the plurality of users;
   receive user-authentication data for the user;
   determine, within the trusted execution environment, whether the user-authentication data satisfies the access policy for the transaction-signing key pair associated with the user; and
   when the user-authentication data satisfies the access policy, use the private key of the transaction-signing key pair associated with the user to sign the transaction, within the trusted execution environment, on behalf of the user, and output data representative of the signed transaction.

In a first set of embodiments, the networked custody server may be configured to store the plurality of private keys in a common encrypted enclave of the one or more encrypted enclaves. In a second set of embodiments, the networked custody server may be configured to store each of the plurality of private keys in a different respective encrypted enclave of the one or more encrypted enclaves.

From a further aspect, the invention provides a computer-implemented method of operating a custody service for signing transactions on behalf of a plurality of users, the method comprising:
storing a plurality of private keys of respective transaction-signing key pairs, associated with a plurality of respective users, in one or more encrypted enclaves of a networked custody server;
storing policy data defining a respective access policy for each transaction-signing key pair in the one or more encrypted enclaves of the networked custody server;
receiving a request to sign a transaction on behalf of a user of the plurality of users;
receiving user-authentication data for the user;
determining, within a trusted execution environment of the networked custody server, whether the user-authentication data satisfies the access policy for the transaction-signing key pair associated with the user; and
in response to determining that the user-authentication data satisfies the access policy, using the private key of the transaction-signing key pair associated with the user to sign the transaction, within the trusted execution environment, on behalf of the user, and outputting data representative of the signed transaction.

From a further aspect, the invention provides a computer program comprising instructions which, when executed by a computer system, cause the computer system to provide a custody service for signing transactions on behalf of a plurality of users, by:
storing a plurality of private keys of respective transaction-signing key pairs, associated with a plurality of respective users, in one or more encrypted enclaves of a networked custody server;
storing policy data defining a respective access policy for each transaction-signing key pair in the one or more encrypted enclaves of the networked custody server;
receiving a request to sign a transaction on behalf of a user of the plurality of users;
receiving user-authentication data for the user;
determining, within a trusted execution environment of the networked custody server, whether the user-authentication data satisfies the access policy for the transaction-signing key pair associated with the user; and
in response to determining that the user-authentication data satisfies the access policy, using the private key of the transaction-signing key pair associated with the user to sign the transaction, within the trusted execution environment, on behalf of the user, and outputting data representative of the signed transaction.

In embodiments of any of the aspects disclosed herein, the computer system may store respective device-to-key mapping data for each of the users. It may be configured to store private keys of transaction-signing key pairs for a plurality of different users. The custody server may be configured to store mapping data associating a public key of a client access key pair of a user device with the transaction-signing key pair associated with the user. The custody server may be configured to use the mapping data and the public key of the client access key pair when determining whether the user-authentication data satisfies the access policy.

In embodiments of any of the aspects disclosed herein, the computer system may be configured to store user-specific policy data associated with respective users of the plurality of users. It may be further configured to store system-wide policy data associated with all of a plurality of users. The custody server may be configured to determine whether to sign a transaction at least partly in dependence on whether received user-authentication data satisfies user-specific policy data and also satisfies system-wide policy data.

The custody server may support an access policy that require a plurality of users (e.g. two or more signatories) to authenticate a single transaction. This may be useful for joint personal accounts or business wallets, e.g. for high-value transactions from such a wallet. The server may be configured to receive user-authentication data for each of a plurality of users and to determine, within the trusted execution environment, whether the user-authentication data of each of the users satisfies the access policy for the transaction-signing key pair.

The request to sign a transaction on behalf of the user may, in some embodiments, comprise a user identifier for the user. The custody server may store ID-to-identity mapping data that associates user identifiers, for a plurality of users, with user-identity data for the respective users. The user-identity data may comprise real-world identity data—e.g. data associated with a physical entity, such as data associated with a paper document, which may identify the user, (e.g. a passport or identity card of the user), or data associated with a building or location (e.g. a residence or workplace of the user). The user-identity data may additionally or alternatively comprise digital-identity data—e.g. data associated with an online service or platform with which the user is registered or enrolled. The user-identity data may comprise or be associated with data issued by an authority (such as a government) and/or a know-your-customer (KYC) service provider and/or any other entity (such as an email provider or a social-media platform operator). For example, the user-identity data may comprise one or more of: an email address, telephone number, a social-media platform account, a passport number, a street address, etc. The ID-to-identity mapping data may be received by the custody server, at least in part, from a transaction-processing system such as a digital asset bank, or it may be generated by the custody server (e.g. through communication between the server and a know-your-customer (KYC) service provider).

The custody server may store ID-to-device mapping data that associates a user identifier with one or more cryptographic client access keys (which may be associated with a user device of the user, e.g. by means of a custody-service app installed on the user's device).

The custody service may be configured to use ID-to-identity mapping data and/or ID-to-device mapping data and/or device-to-key mapping data to associate (e.g. to bind or map) one or more of: user identifiers; user-identity data; client access keys; and transaction-signing key pairs (e.g. wallet keys). It may store the mapping data in a database which may be indexed at least by user identifier. The server may use some or all of the mapping data in a validation process for validating a user device.

These mappings (i.e. bindings) may be used by the custody server to allow users to refer to each other using convenient real-world or digital identity data, such as by email address. The mapping data may be used by the custody server to enable a user to instruct the custody server to sign a transaction (e.g. a cryptocurrency transfer) involving one or more further users by providing user-identity data associated with the one or more further users, such as providing their email addresses. This enables users to interact in a natural way, based on real-world identity information, rather than having to provide unmemorable data such as cryptographic wallet addresses.

The request to sign a transaction on behalf of the user may comprise data relating to the transaction. It may specific an amount for the transaction. It may specify one or more senders (e.g. wallet owner or co-owners) and/or one or more recipients (e.g. payees) for the transaction.

The custody service may be configured to receive a request to sign a transaction on behalf of the user, wherein the request or the user-authentication data comprises real-world identity data, such as an email address. The real-world identity data may identify a recipient for the transaction.

The custody server may be configured to identify one or more parties from a received request. The custody server may be configured to search a mapping database for a respective user identifier or transaction-signing key pair associated with each identified party. The custody server may, in some embodiments, be configured to cause an invitation to enroll with the custody server to be sent (e.g. by email) to an identified party. It may do so in response to determining that the party is not associated with any user identifier or transaction-signing key pair stored in custody server.

The custody server may be configured to store policy data defining a plurality of access policies for the transaction-signing key pair, and may be further configured to deactivate a policy for the transaction-signing key pair in response to receiving a deactivation command.

The custody server may be configured to store a public key of a client access key pair for the user. It may be configured to receive user-authentication data that is cryptographically generated using a private key of the client access key pair—e.g. comprising a challenge issued by the custody server that has been signed with the private key. It may be configured to use the public key of the client access key pair when determining whether the received user-authentication data satisfies the access policy. The client access key pair may be stored on and/or associated with a user device. In this way, use of the client access key pair to sign a challenge can authenticate the user at least by virtue of possession and control of the user device.

The custody server may be configured for enrolling new users. It may be configured to enroll a new user by: receiving a user identifier for the new user; receiving a public key of a client access key pair for the new user; and storing the user identifier and the public key. Enrolling the new user may comprise the custody server generating a transaction-signing key pair for the new user and storing the key pair in an encrypted enclave. Enrolling the new user may comprises the custody server storing device-authentication data for a user device associated with the new user.

The custody server may be configured to provide a recovery mechanism for enabling a user to authorise a transaction when a user device associated with the user (e.g. identified in device-authentication data stored on the custody server) is unavailable (e.g. lost or damaged). The recovery mechanism may comprise the user providing further user-authentication data. The custody server may be configured to determine whether further user-authentication data satisfies a recovery policy for the user. It may be configured to store new device-authentication data for a new device associated with the user in response to determining that the further authentication data satisfies the recovery policy for the user.

The custody server may be configured to maintain a transaction log, which may be a non-repudiable log. It may be configured to store a time-stamped entry in the transaction log when it authorises a transaction on behalf of a user.

The trusted execution environment (TEE) may be provided by an Intel processor that supports Software Guard Extensions (SGX), or an Arm processor that supports TrustZone, or any other processor configured to provide a TEE. The encrypted enclave may be stored in a memory of the custody server. The enclave may be specific to the user, or it may be shared by multiple users. The custody server may be configured to provide a different respective enclave for each of a plurality of users enrolled with the custody server.

The custody server may be a networked server. It may be a located at a single location (e.g. a server farm), or it may be a distributed server system. It may be configured to store a plurality of copies of the private key of the transaction-signing key pair in a plurality of different geographic locations. The custody server may comprise one or more processors and memory storing software instructions for execution by the one or more processors for performing any of the steps disclosed herein.

The computer system may comprise a transaction-processing system, such as a digital asset bank, for performing the transaction on behalf of the user (and optionally for a plurality of other users of the custody server). The transaction-processing system is preferably separate from the custody server, although this is not essential and in some embodiments the custody server may implement one or more or all of the operations of a transaction-processing system as disclosed herein. They may be configured to communicate over the Internet or another network connection. They may be operated by different legal entities. The custody server may be configured to send the data representative of the signed transaction to a transaction-processing system, which may be configured to perform the transaction on an asset of the user (e.g. transferring cryptocurrency from a wallet of the user to an address indicated by the transaction). The transaction-processing system may comprise an asset storage system for storing and/or performing transactions on digital assets belonging to, or associated with, the user. In some embodiments, the transaction-processing system may comprise a cryptocurrency exchange.

The custody server may be configured to receive the request to sign a transaction on behalf of the user from a transaction-processing system. The transaction-processing system may simply relay the request from a user device operated by the user. However, in some situations, the request may originate with the transaction-processing system. This may be useful for performing certain transactions that are not initiated directly by the user in real-time—e.g. for low-value, deferred payment instruction, placed ahead of time by the user with the transaction-processing system (e.g. a cryptocurrency bank).

The user-authentication data for the user may be received from a transaction-processing system in some embodiments or situations. The transaction-processing system may simply relay the user-authentication data from a user device operated by the user (e.g. comprising a user identifier signed with a key associated with the user device). However, in some situations, the user-authentication data may originate with the transaction-processing system (e.g. comprising a user identifier signed with a key associated with the transaction-processing system).

The custody server may be configured to receive system-authentication data for the transaction-processing system—e.g. generated using a transaction-processing-system-access key (a secret system key) stored on the transaction-processing system. The access policy may additionally depend on the system-authentication data. The server may be configured to determine whether the received system-authentication data satisfies the access policy for the transaction-signing key pair. It may be configured use the private key to sign the transaction on behalf of the user only after determining that the system-authentication data satisfies the access policy.

The custody server may comprise an interface for communicating with user devices. It may comprise an interface for communicating with one or more transaction-processing systems. Each interface may be a remote procedure call (RPC) interface.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic diagram of the architecture of a computer system embodying the invention;

FIG. 2 is a protocol sequence diagram of an enrollment process performed by the system;

FIG. 3 is a protocol sequence diagram of a validation process performed by the system;

FIG. 4 is a protocol sequence diagram of a recovery process performed by the system;

FIG. 5 is a protocol sequence diagram of a wallet key-pair creation process performed by the system;

FIG. 6 is a protocol sequence diagram of a transaction-signing process performed by the system;

FIG. 7 is a protocol sequence diagram of a transaction-signing process with device authentication, performed by the system; and

FIG. 8 is a protocol sequence diagram of a policy updating process performed by the system.

### DETAILED DESCRIPTION

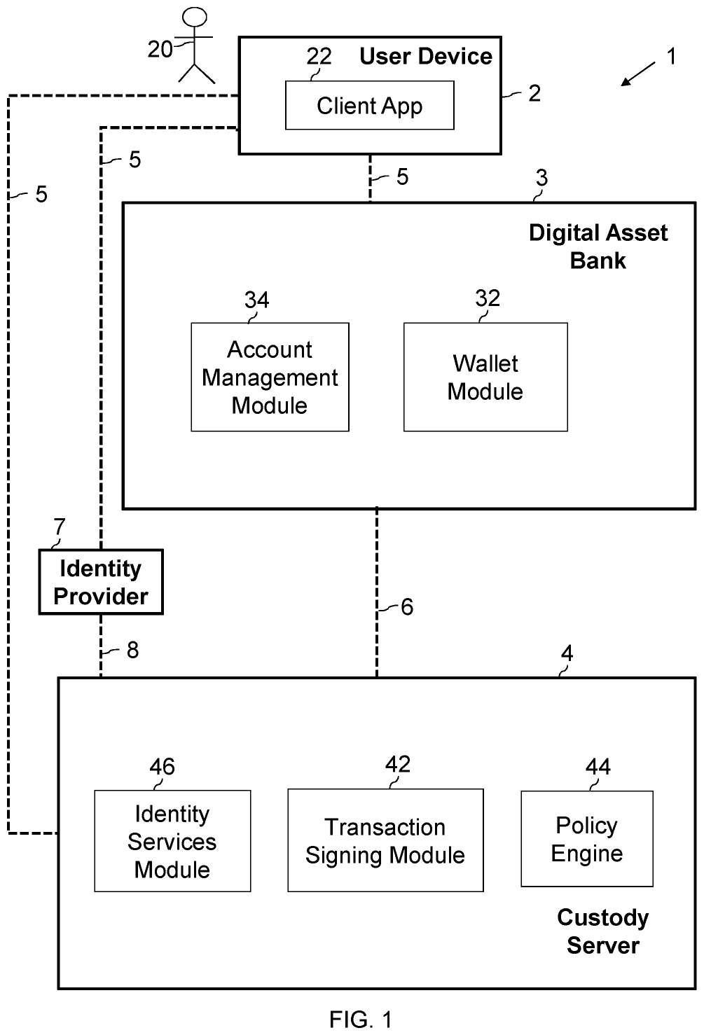

FIG. 1 shows a system 1, embodying the invention, for performing cryptocurrency transactions on behalf of users. One or more user devices 2, such as an Android or Apple cell-phones, can communicate with a digital asset bank (DAB) 3 and with a custody server (CS) 4. The digital asset bank 3 and the custody server 4 are provided by computer server systems that are accessible to the user device 2 over public Internet links 5. Together, the system 1 allows a human user 20 to perform cryptocurrency transactions securely, such as transferring and receiving currency.

The digital asset bank 3 and the custody server 4 in this embodiment are implemented by two separate server systems (e.g. two respective distributed server systems), are may be owned and operated by different entities; they are communicatively linked over an Internet link 6. However, in other embodiments, at least some modules of the digital asset bank 3 and the custody server 4 may be integrated, e.g. on a single platform, which may be operated by one entity. In this case, they may be connected by a local link 6 (e.g. comprising connections within a single computer system, or local area network, or private enterprise network).

The digital asset bank 3 executes a software wallet module 32 for storing and managing users' cryptocurrency. A client application (app) 22 executing on the user device 2 sends instructions to, and receives data from, the digital asset bank 3 through a client app interface. The digital asset bank 3 includes a software account management module 34, such as for enrolling new users and for recovering user accounts in case passwords or keys are lost.

The client app 22 can also interact directly with the custody server 4, over the Internet 5, for certain operations. The custody server 4 executes various software modules, including a transaction signing module 42, a policy engine 44, and an identity services module 46.

The custody server 4 provides a Trusted Execution Environment (TEE) for storing data and software code securely in one or more encrypted enclaves in a memory of the custody server 4, and for executing the software securely. This may be implemented by software that uses Intel Software Guard Extensions (SGX), executing on a suitable processing system, or by using Arm TrustZone mechanisms, or any other similarly technology for providing secure execution environment. The integrity of the data and software in an enclave can be verified at boot time, e.g. using public-key-infrastructure (PKI) mechanisms, and the TEE can protect the code and data from malicious attacks.

The client app 22 and the custody server 4 can also communicate with one or more external identity providers 7, such as Facebook, Twitter, Google, and Microsoft, as well as dedicated know your customer (KYC) service providers.

In use, the custody server 4 provides secure management of cryptocurrency keys, for the DAB 3, over the Internet link 6, through a Remote Procedure Call (RPC) application programming interface (API). It may provide these services to multiple different digital asset banks and for many different end users.

The RPC interface enables the DAB 3 to use the custody server 4 to securely:
manage user profiles, including enrolling new users 20 and generating user-device keys;
create wallet addresses;
sign wallet transactions;
manage wallet keys, including defining and implementing policies for key usage and management; and
recover a user device 2 in case device keys are lost, compromised or expire.

In most use cases, end-user 20 interaction is between the device 2 and the DAB 3, with the DAB 3 forwarding relevant requests to the custody server 4 when required. In some cases, the app 22 executing in the device 2 communicates directly with the custody server 4, over an RPC interface, e.g. to verify information stored within a TEE enclave on the custody server 4.

The following paragraphs describe usage procedures for cryptographic keys used by the CS 4 system when interacting with the DAB 3
and the app 22. Unless stated otherwise, “key” stands for a public-private key-pair. The notation A″ refers to the private part of the key-pair A.

Key-pairs are used for three distinct purposes:
i) Authentication: TLS keys (both server side and client side) are used to provide mutual authentication on the transport layer between the CS 4 and the app 22, and between the CS 4 and the DAB 3.
ii) Authorisation with non-repudiation: Application-level signing keys are used when the app 22 and the DAB 3 need to explicitly authorise requests made towards the CS 4.
iii) Cryptocurrency transaction signing: Cryptocurrency signing keys are stored securely within encrypted enclaves inside the CS 4 and used to sign cryptocurrency transactions.

All cryptographic keys are single-purpose are not for other purposes.

The client application 22 uses the following keys for its interactions with the DAB system 3 and the CS system 4:
CTK: Client TLS Key: used to establish a mutually-authenticated TLS session between the app 22 and the CS 4. The purpose of this key is to authenticate the instance of the app 22 when the app 22 is communicating directly to the CS 4. This provides implicit authentication of the user 20, also, who must authenticate themselves to the user device 2 (e.g. by providing a recognised password or fingerprint), before the app 22 will start.
CTSK: Client Transaction-Signing Key: used to sign transaction authorisations.
CMK: Client Management Key: used to sign all RPC requests that are not transactions authorisations.

The terms CTK, CTSK and CMK are used below to refer to the public parts of the respective key-pairs, unless the context requires the private part.

CAK: Client Access Keys refers to the CTK, CTSK and CMK collectively.

All of these key-pairs are generated by the app 22. The private keys CTK⁻, CTSK⁻ and CMK⁻ are stored within the app 22 and never leave the user device 2. The public keys are shared with the CS 4 during the enrollment and recovery phases.

When communicating with CS 4, the DAB 3 uses the following keys:
DTK: Client TLS Key: used by DAB system components to establish a mutually-authenticated TLS session with the CS system 4. This key serves a similar purpose to CTK but instead of authenticating end-user devices 2, it is used to authenticate modules of the DAB 3. The certificate authority issuing DTK keys may be different from the certificate authority issuing CTK keys.
DTSK: DAB Transaction-Signing Key: used to sign RPC requests which will result in use of cryptocurrency key. This is for the purpose of establishing an accountable audit trail for all cryptocurrency transactions.
DMK: DAB Management Key: used to sign all RPC requests that are not transactions authorisations. When the DAB 3 makes an RPC request that changes the internal state of the CS 4 (e.g., enrollment, recovery, setting policies, etc.), the CS 4 requires explicit nonrepudiable authorisation for the purpose of establishing an accountable audit trail.

These DAB access keys (DAK) are generated by the DAB 3 and exchanged via a secure offline channel as a part of the system setup procedures.

The custody server 4 system uses server-side TLS keys for the purpose of establishing mutually-authenticated channels to the CS 4 from the app 22 and from the DAB 3 (along with client-side TLS certificates defined above).

The CS 4 generates and maintains the following keys:
CCA: Certificate-Authority Client Root key: used to sign end-user client TLS certificates stored on the app 22. This Certificate Authority (CA) is online (e.g. accessible over the Internet) and runs inside a trusted execution environment (TEE).
DCA: DAB Certificate-Authority Root key: used to sign client TLS certificates for system components of the DAB 3. This CA is offline and used only during system setup procedures.
CSMK: Custody-Server Management Key: used to provide non-repudiable assertions to the DAB 3 and app 22, e.g. confirming bindings between user identities, wallet keys, and device keys.
WK: Wallet Keys: cryptocurrency keys, the public parts of which are shared with the DAB 3 and app 22 during wallet key-pair creation, and the private parts of which are used by the CS 4 to sign cryptocurrency transactions. These WK are “transaction-signing key pairs” as disclosed elsewhere herein. These keys may be specific to particular currencies, e.g. Wallet Keys for Bitcoin (“WKB”), Wallet Keys for Ethereum (“WKE”), etc.

Various Key-Identity bindings can be established:
the DAB 3 creates the tuple (KYC, UserID, *). The DAB 3 issues an assertion confirming this binding, signed with DMK--.
the CS 4 creates the tuple (CAK, Wallet Keys (WKB, WKE, . . . ), UserID). The CS 4 issues an assertion confirming this binding, signed with CSMK--.

As part of the enrollment, recovery and key-pair creation flows, the DAB 3 and CS 4 exchange these tuples and corresponding assertions.

Here, UserID is a user identifier (which could be an arbitrarily-allocated number, or the full name of the user 20, etc.). KYC (know your customer) refers to data suitable for verifying the real-world identity of a user 20; this data may have a variable level of confidence associated with it, depending on the source and type of the data (e.g. a single-sign-on assertion from a social-media platform may provide lower confidence than a government-issued smart-card identity card).

The DAB 3 is typically responsible for establishing the binding of the user identifier to one or more real-world identifiers, e.g., legal name, official ID number. The CS 4 is responsible for establishing the binding of the Wallet Keys to the Client Access Keys—i.e., it binds the user device 2 running the app 22 to a wallet that is stored in the CS 4. Through the enrollment and key-pair creation processes, described below, the CS 4 is able to acquire and store mapping data that associates, or binds together: a user's real-world identity data (KYC), the user's identifier (UserID), the user's device-specific client access keys (CAK), and the user's private transaction-signing wallet keys (WK). This binding provides both security and convenience benefits.

The DAB 3, CS 4, and the app 22 use UserID as a reference for a particular user 20. It is typically used as an identity assertion. UserID doesn't need to be exposed to the user.

The above bindings allow users 20 to refer to each other (in interactions with the DAB 3 and CS 4) conveniently, using, for example, email addresses, or social-media platform usernames, and to transfer funds to each other in a natural way, relying on their real-world identities. This can provide much greater simplicity and user convenience than having to know and provide Wallet Keys or randomly-generated user identifiers.

In order to expand the reach of this mechanism, the system 1 may, in some embodiments, automatically send an invitation (e.g. by email) to any individual who is identified in a transaction, but not yet registered on the system with a UserID, inviting them to enroll.

The DAB 3 will typically further authenticate the user 20 using mechanisms that are independent from the mechanisms that the CS 4 uses to authenticate the user 20—e.g. through a username and password for logging on to its cryptocurrency bank platform.

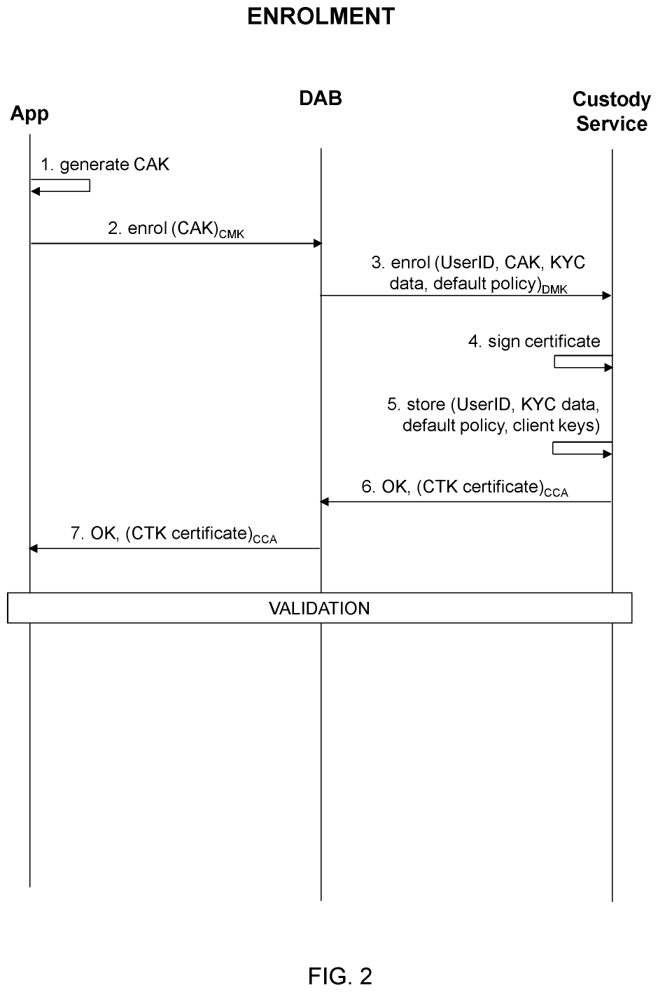

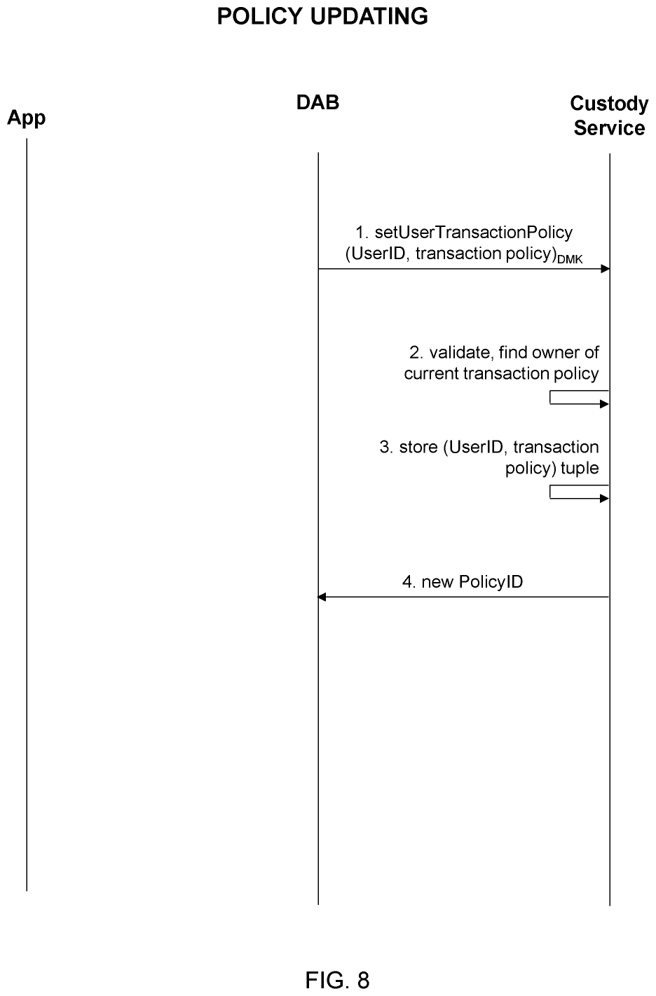

Operation flows for the following processes will now be described in detail, with reference to FIGS. 2-8:
enrollment
user-data validation
recovery
wallet key-pair creation
cryptocurrency transaction signing (without device authentication)
cryptocurrency transaction signing (with device authentication)

Use of a key to sign data is indicated in FIGS. 2-8 by the abbreviated key name in subscript after the data.

### Enrollment

FIG. 2 shows an enrollment process, used to enroll a new user 20 with the DAB 3.

In a first step of the enrollment, the app 22 creates Client Access Keys (CAK) and sends an enrollment message (signed with the private part CMK″ of the CMK) to the DAB 3 (step 2). The DAB 3 assigns a new UserID to the received CAK keys. The DAB 3 then obtains appropriate real-world identity (KYC) data for the user 2, e.g. from one or more external identity providers 7, and forwards the tuple (KYC, UserID, CAK) to the CS 4 (step 3). The tuple may also include policy data defining a default access policy to be applied to any transaction-signing wallet key pairs generated for the user. When the wallet keys (WK) are later created, the CS 4 will bind the created wallet keys to this UserID and CAK, and will store this association in mapping data.

In step 4, the CS 4 creates a certificate for the CTK. In step 5, the CS 4 creates and stores a new user profile in an encrypted TEE enclave for the user 20. It then sends the certificate to the DAB 3 (step 6), which forwards it on to the app 22 (step 7).

The DAB 3 and/or CK 4 may perform identity verification processes, to verify the identity of the user 20, at appropriate points in the process, if desired.

At the end of the enrollment, the app 22 performs a validation process by opening an end-to-end TLS connection to the CS 4, using CTK as a client-side key. Within this TLS connection, the CS 4 checks that the app 22 holds all three keys of the CAK. This process will now be described in more detail.

### Validation

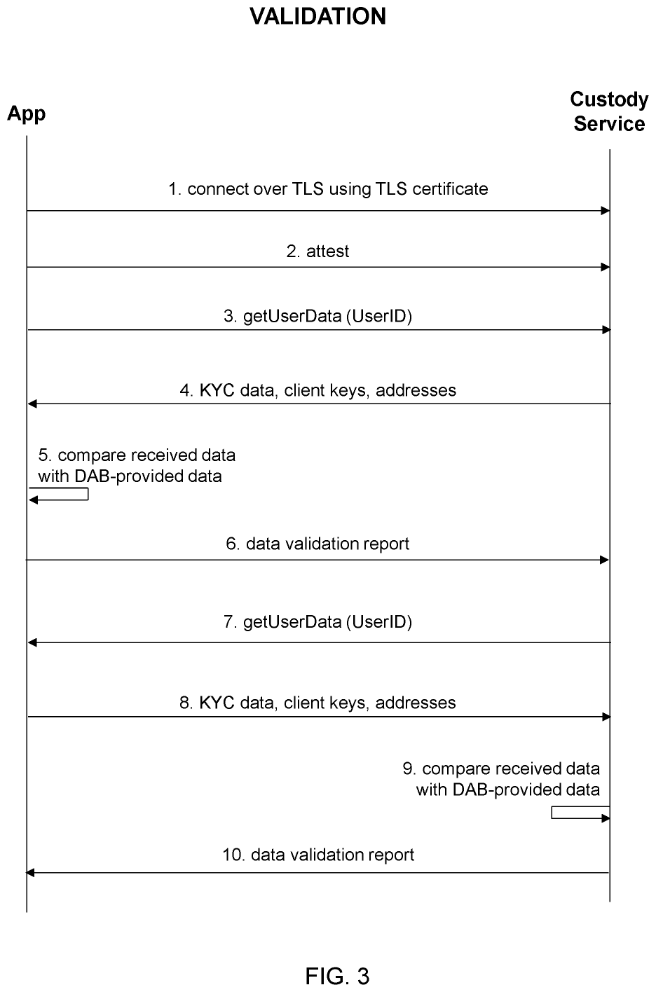

FIG. 3 shows a validation process for validating user data between the app 22 and the CS 4. It allows the parties to verify the bindings between the keys and identities. In particular, it serves to confirm to the app 22 and the CS 4 that they hold the same bindings, most critically between the CAK and the Wallet Keys. It therefore enables the CS 4 to authenticate the app 22, and vice versa.

User-data validation is used:
after Enrollment and Recovery, to validate that the client access keys CAK as reported by the CS 4 are identical to the client keys generated on the app 22
after key-pair creation, to validate that the public keys and addresses reported by the CS 4 are identical to the public keys and addresses reported by the DAB 3
to get a list of public keys/addresses for other purposes.

This validation protects the CS 4 and app 22 against malicious actions by the DAB 3 (e.g., in case of the DAB 3 is compromised by an attacker).

In the first two steps of the protocol, the app 22 opens a TLS connection to the CS 4 using its CTK and attests the CS 4 (e.g. using Intel SGX remote attestation), so as to establish an attested end-to-end TLS connection. The app 22 and CS 4 may communicate directly over an Internet channel 5, or via the DAB 3 (albeit unreadably to the DAB 3).

In a third step, the app 22 requests user data from the CS 4 through a getUserData API, to which the CS 4 responds by sending the associated user data, which may include KYC data, CAK, wallet addresses and Wallet Keys, for the UserID. The app 22 compares the received data with the versions it stores (step 5), and communicates the result of the comparison to the CS 4 (step 6).

Similarly, in steps 7-10, the CS 4 requests the same data from the app 22, and verifies that it is consistent with the versions it has stored in the user enclave.

If either party detects an inconsistency, it may flag this as a security alert to the user or to an operator, and block further transactions until the matter has been resolved.

### Recovery

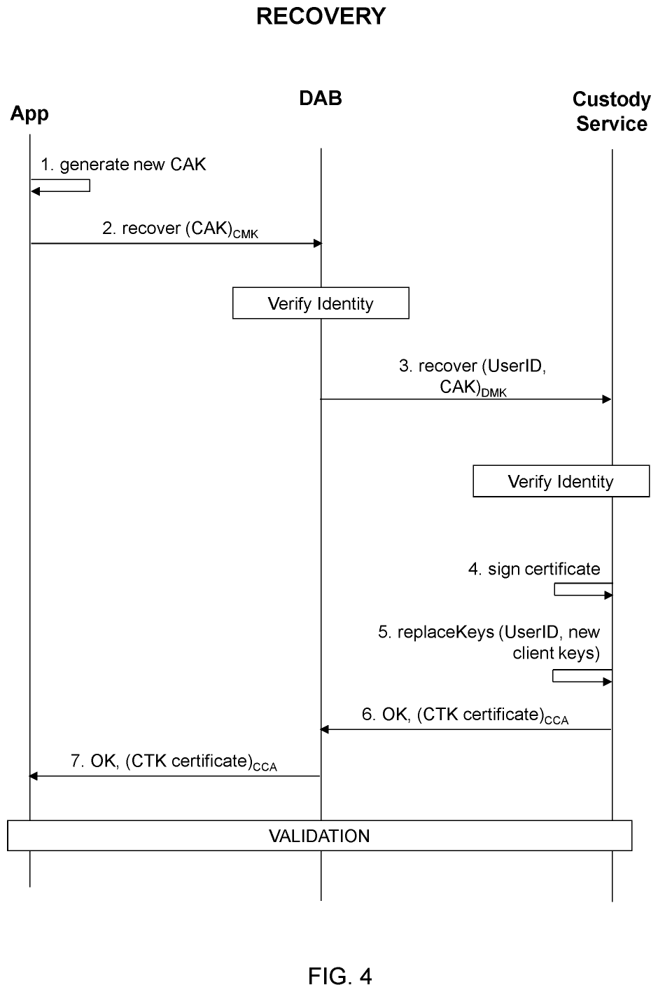

FIG. 4 shows a recovery procedure, for storing new device keys if the existing device keys have been lost or compromised.

It has a flow similar to the enrollment process in FIG. 2, but with the new device keys replacing the existing device keys.

Also, unlike enrollment, the recovery procedure typically requires additional identify verification steps to prevent fraudulent recovery requests. Before completing the recovery process, both the DAB 3 and the CS 4 system perform their own identity verification procedures (not shown in detail in FIG. 4), the nature of which may depend on the amount of cryptocurrency available for the account being recovered. For example, identity verification for accounts with a very large amount of cryptocurrency may require in-person verification of identity by the DAB 3, along with a manual offline procedure by the CS 4.

In this example embodiment, the app 22 first creates new Client Access Keys (CAK) (step 1) and sends them in a recovery message to the DAB 3 (step 2). After the user has adequately authenticated themselves to the DAB 3 through the app 2, the DAB 3 send the UserID and new CAK to the CS 4 (step 3). The CS 4 may require further successful identity verification, by any suitable mechanism, before proceeding. It then creates a new certificate for the CTK (step 4). In step 5, the CS 4 updates the user profile by storing the new CAK in the encrypted enclave of the user 20. It then sends the new certificate to the app 22, via the DAB (steps 6 & 7).

At the end of the recovery, the app 22 performs a validation process by opening an end-to-end TLS connection to the CS 4, using CTK as a client-side key. Within this TLS connection, the CS 4 checks that the app 22 holds all three keys of the new CAK.

### Wallet Key-Pair Creation

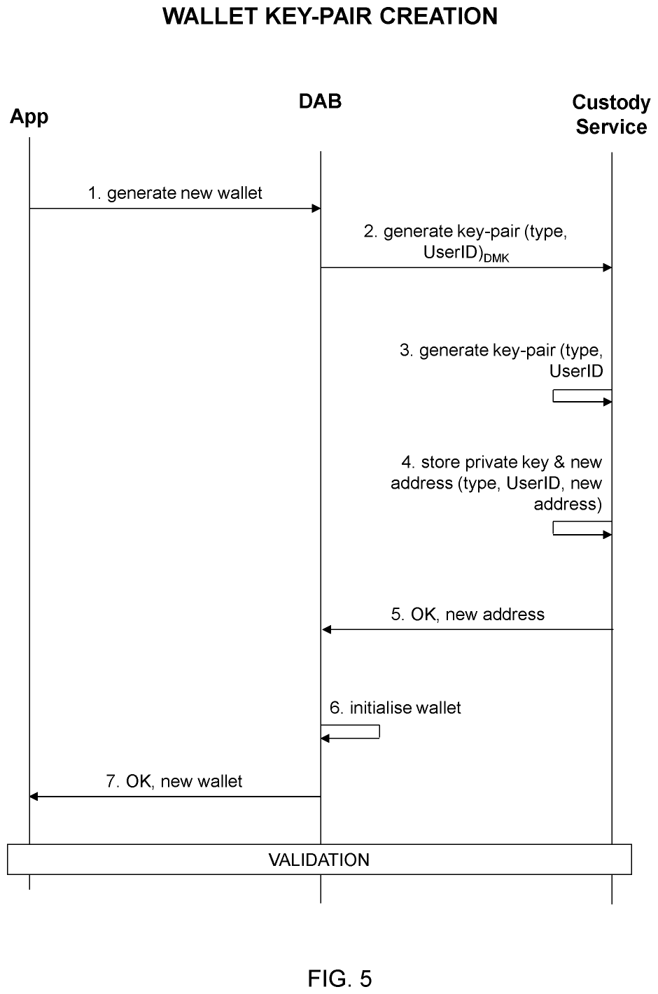

FIG. 5 shows a wallet creation process. This is similar for most cryptocurrencies and digital assets.

A request to generate a new wallet for the user 20 is sent from the app 22 to the DAB 3 (step 1). The DAB 3 sends a corresponding key-pair generation instruction to the CS 4, naming the UserID and a required type of key-pair (e.g. Bitcoin) (step 2). The CS 4 generates a Wallet key-pair for the indicated cryptocurrency or digital asset (step 3). It stores the private key and the wallet public key and/or wallet address (which may be calculated from the corresponding public key according to a defined protocol, e.g. as bytes of a hash of the public key for an Ethereum address) in the user's enclave (step 4). The CS 4 also binds the Wallet Key to the CAK of the user 20 from whom the request originated; this binding will be validated subsequently in the user validation step. The CS 4 then sends the wallet address to the DAB 3 (step 5), which stores and initialises the wallet within its banking architecture (step 6). The DAB 3 indicates a successful initialisation by sending the wallet address to the app 22 (step 7).

The app 22 and CS 4 then perform a validation process (see FIG. 3) to mutually verify the binding of the CAK to the wallet key or address.

The wallet generation request does not have to originate from the app 22. For example, the DAB 3 may initiate the request in some embodiments. However, the app 22 must be involved in order to perform the user validation step before the protocol can successfully complete.

Cryptocurrency Transaction Signing (without Authentication)

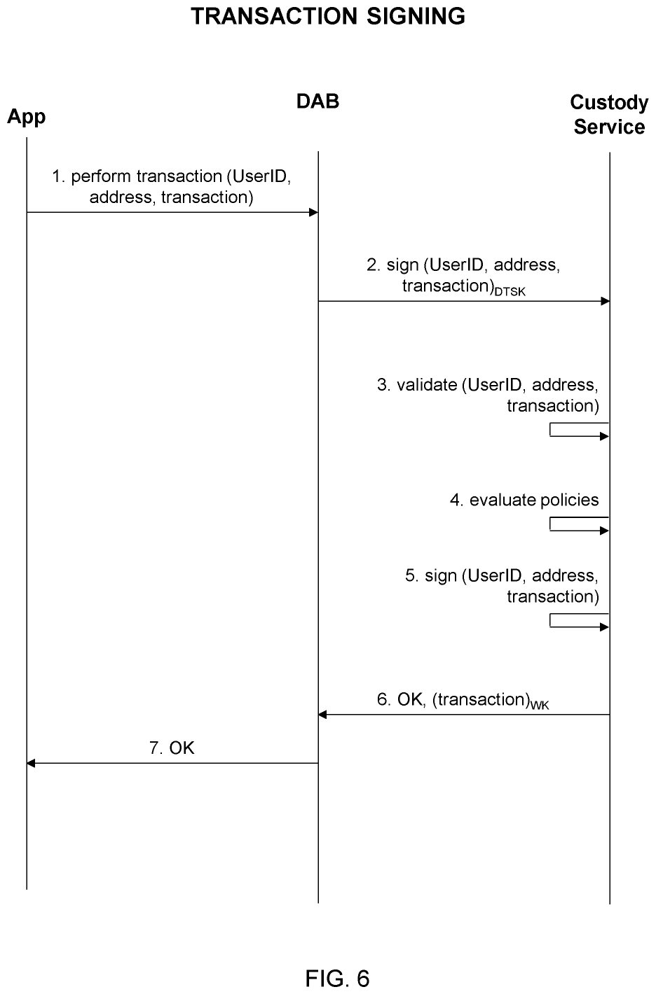

FIG. 6 shows a process of performing a cryptocurrency transaction, such as paying value out of a wallet. This process involves the custody server 4 signing a transaction on the user's behalf, within the secure TEE enclave that has previously been initialised for the user 20 on the CS 4.

In this particular example, the user 20 unlocks their device 2 and tells the app 22 to instruct the DAB 3 to make a transaction. The user 20 authenticates themselves to the DAB 3 (e.g. by logging in with a password) and the app 22 sends an instruction to the DAB 3 (step 1), specifying the source wallet address of the user 20, the user's UserID and transaction details (e.g. a payment instruction, with an amount and a destination wallet address). The DAB 3 performs any necessary internal processes (e.g. logging the transaction request) and sends a request to sign the transaction to the CS 4 (step 2).

The CS 4 validates the parameters received from the DAB 3 for consistency (step 3), and determines, using the policy engine 44 executing within a TEE enclave associated with the user 20, whether the user-authentication data (e.g. the UserID, received over an authenticated TLS channel with the DAB 3) satisfies an access policy for the Wallet key pair indicated by the address parameter. This policy may specify who can authorise any, or certain, transactions for the wallet. It may additionally specify conditions, e.g. relating to who may receive currency from the wallet, or to the amount of currency currently in the wallet, which the policy engine 44 also processes.

Assuming the user-authentication data, and any other required conditions for the requested transaction, satisfy the access policy, the CS 4 builds and signs the transaction with the wallet private key, using the transaction signing module 42 executing within the TEE enclave associated with the user 20 (step 5). It sends the signed transaction back to the DAB 3 as byte array (step 6). The DAB 3 can then implement the authorised transaction, e.g. by performing appropriate operations on a blockchain of the cryptocurrency.

If the policy evaluation (step 4) determines that the request does not fully satisfy the access policy, it may be declined, or the signing process may continue with a request for additional authorisation. For example, the access policy may cause the policy engine 44 to allow transactions up to $100 to proceed without interactive user authorisation, and allow transactions between $100 and $10,000 to proceed with single-user authorisation, but to require multiple-user authorisation (e.g. three out of five recognised signatories) for transactions over $100,000. In this last case, it will defer signing the transaction until it has received respective user-authentication data interactively, over verified TLS connections, from the required number users.

Although, in this example, the user 20 has initiated the transaction from the app 22, by logging on to the DAB 3, in other situations the DAB 3 might initiate the transaction signing request without the user 20 being present—e.g. when implementing a recurring standing order placed with the bank 3 the user 20. In both cases, the CS 4 receives user-authentication data only from the DAB 3, and not through direct communication with the app 22, so must trust that the DAB 3 has not been compromised. As already noted above, a wallet policy may allow such transactions up to a certain value, but require the user 20, or a set of users, to authenticate themselves to the CS 4 interactively—i.e. in response to requests from the CS 4 sent to apps 22 running on respective enrolled personal devices 2 of the users—in order to authorize higher-value transactions. This process will now be described.

Cryptocurrency Transaction Signing (with Authentication)

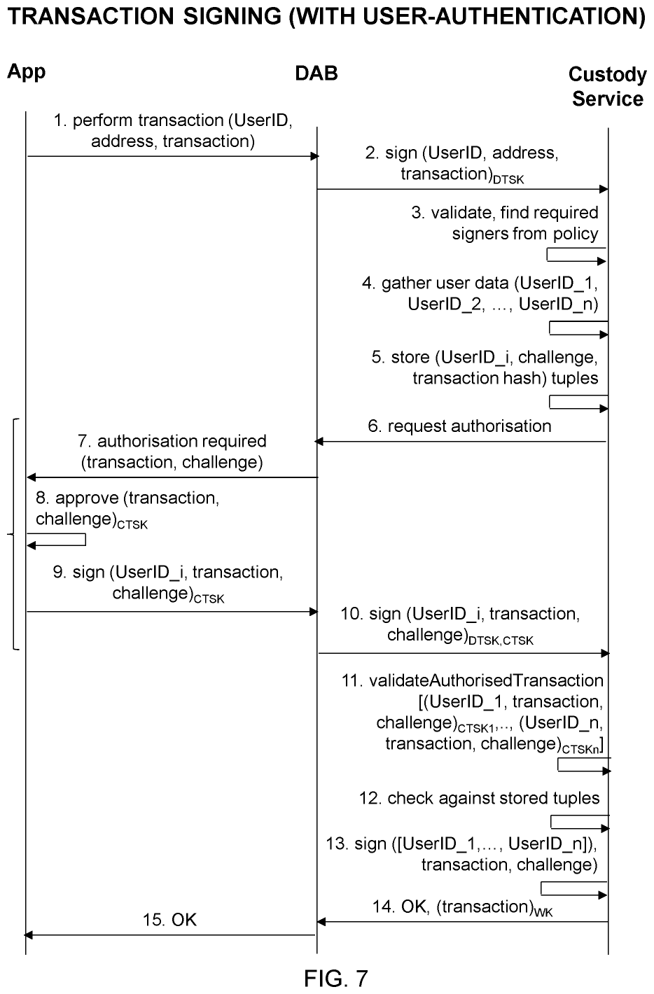

FIG. 7 shows a process of performing a cryptocurrency transaction with device-based user authentication.

The first two steps are the same as for FIG. 6. In step 3, the policy engine 44 of the CS 4 determines that the transaction needs to be authorised by one or more users, and gathers (step 4) the user data for the corresponding user identities, UserID_1, UserID_2, . . . , UserID_n. The CS 4 generates a challenge for each user and stores a tuple of (UserID, challenge, transaction hash) for each UserID (step 5). It sends a corresponding authorisation request to the DAB 3 (step 6) containing a list of all users that are needed to authorise the transaction.

The DAB 3 contacts the apps 22 of the user devices 2 of each of the users in the set and sends respective authorisation requests, containing the transaction details and the respective challenges generated by the CS 4 (step 7). The devices 2 may notify the users. As each user approve the transaction (step 8), their app 22 sends signed approval to the DAB 3 (signed with the respective Client Transaction-Signing Key), authorising the CS 4 to sign the transaction on the user's behalf (step 9). The DAB 3 adds its signature using the DAB Transaction-Signing Key and forwards the authorised signature instruction to the CS 4 (step 10). These steps 7-10 are repeated for each user of the set until the DAB 3 determines that a sufficient number signatories have provided authorisation.

The CS 4 validates the set of signed transaction authorisations (step 11) and checks the received data against the tuples stored, in the policy engine 44, in step 5 (step 12). By storing the tuples (UserID, challenge, transaction hash) before requesting the user authorisations, and checking the challenges and transaction hash when validating the incoming signing requests in the policy engine 44, the CS 4 can provide integrity protection to the authorisation transaction.

Assuming the tuples match, it signs the transaction on behalf of the set of users (step 13), and returns the signed transaction to the DAB 3 (step 14). The signing is performed by the signing module 42 executing in the respective enclaves.

The DAB 3 may then implement the authorised transaction, e.g. by performing appropriate operations on a blockchain of the cryptocurrency.

In this example, the transaction was initiated by the user 20 of the app 22, and so the DAB 3 reports success to the app 22. In other scenarios, the transaction may be initiated by the DAB 3.

### Other Features

In addition to the protocols described above, the CS 4 supports other operations, including editing user profile data, setting access policies, and logging.

The identity services module 46 exposes APIs for editing an existing user's KYC data (e.g., adding an email address, editing a phone number, etc.), and for editing device bindings (e.g. de-registering a device from a user profile).

The CS 4 maintains a transaction log. This may, for example, include logging that UserID A transferred amount X to UserID B. For privacy reasons, logging data may be obfuscated (e.g. removing or scrambling names, identifiers, etc.). The CS 4 may log bindings and/or transactions on a distributed ledger which may be public or private, and which may be permissioned or permissionless.

The policy engine 44 implements access policies for wallet keys. Policies may be attached to a user, or to a key-pair (e.g. to a wallet address), or may be system-wide. Every time a user 20 tries to sign a transaction, the CS 4 applies all the policies associated with the user 20 who is requesting the transaction, and the policies associated with the transaction-signing keys related to the source wallet address for transaction. The CS 4 also applies all system-level policies. These may be applied first. Policies may be sorted by priority, and the engine 44 may verify them in descending order of their priority.

In some embodiments, by default, if no policies are set for user 20, every transaction for that user 20 will be denied. However, a default policy may be set by the DAB 3 in step 3 of the enrollment process of FIG. 2 to avoid this occurring.

The DAB 3 can define and assign policies to users through an API to the policy engine 44. The API allows a policy to be added for a user, or disabled.

The CS 4 stores all policies with their associated metadata (e.g., priority, scope, type, etc.). Once all policies related to a user 20 are fetched by the engine 44, in response to a signing request, they are executed in priority order and can result in one of three outcomes:
the transaction is denied if one of the policy conditions was not met;
the transaction is approved if all policies evaluated successfully; or
the transaction needs further authorisation by one or more users.

Available policy types for a user may include:
a policy to approve all transactions;
a policy to require N out of M defined users to authorize a transaction in order for transaction to be allowed;
a policy to allow the user to transfer up to an specified amount without being authorized, but with any amount greater or equal this level causing the policy engine 44 to request authorization;
a policy to allow the user to transfer up to an specified amount to an address X without being authorized, but with any amount greater or equal this level to address X causing the policy engine 44 to request authorization;
a policy to require authorisation every N transactions no matter what the transaction amount is;
a policy to deny all transactions to an address X. If set with a higher priority than other policies, this will cause the CS 4 to automatically deny all such transactions, i.e. black-listing the address X;
a policy to allow all transactions to an address X. If set with a higher priority than other policies, this will cause the CS 4 to automatically deny all such transactions, i.e. white-listing the address X.

In addition to policies associated with a user or wallet, which may be in force over a prolonged period of time, potentially covering lots of transactions, the system 1 may also support the enforcing of conditions that are associated with one specific transaction. This can allow a sender of currency to specify, for example, a set of identity attributes that are required of a recipient of the transaction, in order for the policy engine 44 to approve the transaction.

A sender (payer) may, for instance, specify that a particular transaction requires a verification of real-world identity (e.g. a name on a passport, or a passport number, or proof of citizenship), or of one or more digital identities (Google, Facebook, etc.), or a phone numbers, or through an interactive challenge-response protocol, or some combination thereof. The sender may specify that funds can be spent only in certain ways, or within a specified period of time.

These access conditions and policies may be specified not only by the sender but can also be system-imposed or tied to regulations. The policy engine 44 of the Custody Server 4 can ensure that funds can be accessed only when the conditions are met, and spent according to the policies. This is enforced by the CS 4 which manages the account and address.

This mechanism may be particularly powerful when both (or all) parties to a transaction are enrolled users of the system 1. If a party to a transaction (e.g. a recipient of currency in a transaction initiated by the user 20) is not recognised by the system 1, the app 22 or DAB 3 may ask the CS 4 to open a new wallet address for the party. The user 20 may have identified the recipient by one or more real-world or digital identifiers—e.g. “Joe Bloggs”, who has email address “joe@gmail.com”, is a “German” national, and has cell-phone number “+1234123123123”. The user 20 may impose that access is only granted if the recipient can prove that it has access to “joe@gmail.com”, cell-phone number “+1234123123123”, and presents a German passport or ID through a KYC service 7. The user 20 may further specify that Joe can spend up to 10% of the transferred funds each week, always requiring cell-phone number “+1234123123123” as a transaction confirmation second-factor, and only when connecting from a particular jurisdiction, e.g. using a device having an IP address that geolocates to Germany.

The CS 4 can also check a binding between digital and physical identities of users, by storing a binding between two or more different identifiers for a user that are presented to the CS 4 within the same authenticated session. For example, if a user 20 authenticates with the CS 4 via a Gmail account, and within the same session submits a copy of their passport and a facial-recognition biometric, the identity services module 46 may bind the Gmail account with the user's legal identity and biometrics and store this in an enclave of the user 20. The CS 4 may be able to perform active authentication with e-passports, if available. This facilitates using the services of existing digital and manual KYC identity providers 7 for authenticating users to the CS 4. If a plurality of such authentications happen within the same session, these identities can then be considered as ‘bound’.

It will be appreciated by those skilled in the art that the invention has been illustrated by describing one or more specific embodiments thereof, but is not limited to these embodiments; many variations and modifications are possible, within the scope of the accompanying claims.

1. A computer system comprising a networked custody server for signing transactions on behalf of a plurality of users,
wherein the networked custody server comprises a processor configured to provide a trusted execution environment for securely decrypting and executing software instructions that are stored in an encrypted enclave of the custody server, and
wherein the custody server is configured to:
store a plurality of private keys of respective transaction-signing key pairs, associated with a plurality of respective users, in one or more encrypted enclaves of the custody server;
store policy data defining a respective access policy for each transaction-signing key pair in the one or more encrypted enclaves;
receive a request to sign a transaction on behalf of a user of the plurality of users;
receive user-authentication data for the user;
determine, within the trusted execution environment, whether the user-authentication data satisfies the access policy for the transaction-signing key pair associated with the user; and
when the user-authentication data satisfies the access policy, use the private key of the transaction-signing key pair associated with the user to sign the transaction, within the trusted execution environment, on behalf of the user, and output data representative of the signed transaction.

2. The computer system of claim 1, wherein the networked custody server is configured to store the plurality of private keys in a common encrypted enclave of the one or more encrypted enclaves.

3. The computer system of claim 1, wherein the custody server is configured to store each of the plurality of private keys in a different respective encrypted enclave of the one or more encrypted enclaves.

4. The computer system of claim 1, wherein the custody server is configured to receive the user-authentication data from a user device, and is further configured to receive device-authentication data for the user device, and wherein the access policy depends on the device-authentication data, and the custody server is configured to determine whether the received device-authentication data satisfies the access policy.

5. The computer system of claim 1, wherein the custody server is configured to store a public key of a client access key pair for the user, and is configured to receive user-authentication data that is cryptographically generated using a private key of the client access key pair, and to use the public key of the client access key pair when determining whether the received user-authentication data satisfies the respective access policy.

6. The computer system of claim 1, wherein:
the custody server is configured to store mapping data associating a public key of a client access key pair of a user device with the transaction-signing key pair associated with the user;
the user-authentication data is received by the custody server from the user device, and is cryptographically generated by the user device using a private key of the client access key pair; and
the custody server is configured to use the mapping data and the public key of the client access key pair when determining whether the user-authentication data satisfies the access policy.

7. (canceled)

8. The computer system of claim 1, wherein each access policy specifies a respective authentication attribute, and wherein the custody server is configured to determine, within the trusted execution environment, whether the received user-authentication data satisfies the authentication attribute specified by the access policy for the transaction-signing key pair associated with the user, and to use the private key to sign the transaction, on behalf of the user, at least in part in response to determining that the user-authentication data satisfies the authentication attribute.

9. (canceled)

10. The computer system of claim 1, wherein the access policy for the transaction-signing key pair associated with the user specifies a transaction attribute, and wherein the custody server is configured to determine, within the trusted execution environment, whether the transaction attribute specified by the access policy is met by the transaction, and to use the private key to sign the transaction, on behalf of the user, at least in part in response to determining that the transaction satisfies the transaction attribute.

11. (canceled)

12. The computer system of claim 1, wherein the access policy for the transaction-signing key pair associated with the user specifies a plurality of transaction attributes and a plurality of authentication attributes, and further associates each transaction attribute of the plurality of transaction attributes with at least one authentication attribute of the plurality of authentication attributes, and wherein the custody server is further configured to determine whether the received user-authentication data satisfies an authentication attribute associated with a transaction attribute of the transaction, and to use the private key to sign the transaction, on behalf of the user, at least in part in response to determining that the received user-authentication data satisfies every authentication attribute associated with every transaction attribute of the transaction.

13. The computer system of claim 1, wherein the transaction is a cryptocurrency transaction having an associated value, and wherein the access policy for the transaction-signing key pair associated with the user specifies a type of user-authentication data that the received user-authentication data must satisfy, selected from a plurality of types in dependence on the value of the transaction.

14. The computer system of claim 1, wherein the custody server is configured to store user-specific policy data associated with respective users of the plurality of users, and is further configured to store system-wide policy data associated with all of the plurality of users, and wherein the custody server is configured to determine whether to sign a transaction, on behalf of a user, at least partly in dependence on whether received user-authentication data satisfies user-specific policy data and also satisfies system-wide policy data.

15. The computer system of claim 1, wherein the access policy for the transaction-signing key pair associated with the user requires a plurality of authenticating users to authenticate a single transaction, and wherein the custody server is configured to receive user-authentication data for each of the plurality of authenticating users and to determine, within the trusted execution environment, whether the user-authentication data of each of the authenticating users satisfies the access policy.

16. The computer system of claim 1, wherein the request to sign a transaction on behalf of the user comprises a user identifier for the user, and wherein the custody server is configured to store data mapping user identifiers, for the plurality of users, to real-world or digital identity data associated with the respective users.

17. (canceled)

18. The computer system of claim 1, wherein the custody server is configured to store policy data defining a plurality of access policies for the transaction-signing key pair associated with the user, and is further configured to deactivate a policy for the transaction-signing key pair in response to receiving a deactivation command.

19. The computer system of claim 1, wherein the custody server is configured to enroll a new user by:
receiving a user identifier for the new user;
receiving a public key of a client access key pair for the new user;
storing the user identifier and the public key;
generating a transaction-signing key pair for the new user; and
storing the generated key pair in an encrypted enclave of the custody server.

20. The computer system of claim 1, wherein the custody server is configured to provide a recovery mechanism for enabling a user to authorise a transaction when a user device associated with the user is unavailable, wherein the custody server is configured to determine whether further user-authentication data received from the user satisfies a recovery policy for the user, and to store new device-authentication data for a new device associated with the user in response to determining that the further authentication data satisfies the recovery policy for the user.

21. (canceled)

22. (canceled)

23. The computer system of claim 1, further comprising a transaction-processing system for performing the transaction on behalf of the user, wherein the custody server is configured to send the data representative of the signed transaction to the transaction-processing system.

24. The computer system of claim 1, wherein the custody server is configured to receive the request to sign a transaction on behalf of the user, over a network connection, from a transaction-processing system.

25. A computer-implemented method of operating a custody service for signing transactions on behalf of a plurality of users, the method comprising:
storing a plurality of private keys of respective transaction-signing key pairs, associated with a plurality of respective users, in one or more encrypted enclaves of a networked custody server;
storing policy data defining a respective access policy for each transaction-signing key pair in the one or more encrypted enclaves of the networked custody server;
receiving a request to sign a transaction on behalf of a user of the plurality of users;
receiving user-authentication data for the user;
determining, within a trusted execution environment of the networked custody server, whether the user-authentication data satisfies the access policy for the transaction-signing key pair associated with the user; and
in response to determining that the user-authentication data satisfies the access policy, using the private key of the transaction-signing key pair associated with the user to sign the transaction, within the trusted execution environment, on behalf of the user, and outputting data representative of the signed transaction.

26. A non-transitory computer readable storage medium storing instructions which, when executed by a computer system, cause the computer system to provide a custody service for signing transactions on behalf of a plurality of users, by:
storing a plurality of private keys of respective transaction-signing key pairs, associated with a plurality of respective users, in one or more encrypted enclaves of a networked custody server;
storing policy data defining a respective access policy for each transaction-signing key pair in the one or more encrypted enclaves of the networked custody server;
receiving a request to sign a transaction on behalf of a user of the plurality of users;
receiving user-authentication data for the user;
determining, within a trusted execution environment of the networked custody server, whether the user-authentication data satisfies the access policy for the transaction-signing key pair associated with the user; and
in response to determining that the user-authentication data satisfies the access policy, using the private key of the transaction-signing key pair associated with the user to sign the transaction, within the trusted execution environment, on behalf of the user, and outputting data representative of the signed transaction.
